(19) United States
(12) Patent Application Publication
(10) Pub. No.: US 2024/0359459 A1
(43) Pub. Date: Oct. 31, 2024

(54) IMAGE FORMING APPARATUS

(71) Applicant: KYOCERA Document Solutions Inc., Osaka (JP)

(72) Inventors: Naoko Kawashima, Osaka (JP); Hiroomi Nakatsuji, Osaka (JP); Jun Nakano, Osaka (JP); Masato Usui, Osaka (JP)

(21) Appl. No.: 18/641,291

(22) Filed: Apr. 19, 2024

(30) Foreign Application Priority Data
Apr. 27, 2023 (JP) 2023-072907

(51) Int. Cl. B41J 2/12; B41J 2/045; B41J 29/393

(52) U.S. Cl. CPC B41J 2/12; B41J 2/04508; B41J 2/0451; B41J 2029/3935

(57) ABSTRACT

An ejection malfunction nozzle detecting unit prints plural test patterns on a print sheet using a recording head, and detects ejection malfunction nozzles on the basis of scanned images of the plural test patterns. The plural test patterns are line-shaped or band-shaped images for which a correction process has been performed at plural nozzle positions with a predetermined period. The nozzle positions of the plural test patterns are specified with offset positions different from each other. Further, the ejection malfunction nozzle detecting unit (a) determines a test pattern that densities at periodical ejection malfunction positions have been corrected among the plural test patterns on the basis of density distributions of scanned image of the test patterns, and (b) stores as ejection malfunction nozzle data an offset position of the determined test pattern into a storage device.

### CROSS-REFERENCE TO RELATED APPLICATIONS

This application relates to and claims priority rights from Japanese Patent Application No. 2023-072907, filed on Apr. 27, 2023, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus prints a test pattern using a recording head; on the basis of an image of the printed test pattern, detects an ejection malfunction nozzle that can not properly eject ink among nozzles that eject ink in the recording head; and increases an ink amount of an adjacent dot.

Another inkjet image forming apparatus detects an ejection malfunction nozzle that has a cause other than an initial deviation of a droplet hitting position.

In the aforementioned technique, data of nozzle positions of ejection malfunction nozzles is stored in a memory or the like, and when an image specified by a user is printed, the ejection malfunction nozzles are determined on the basis of the data, and a correction process is performed using nozzles adjacent to the ejection malfunction nozzles.

However, if there are a lot of ejection malfunction nozzles, then the data that indicates the ejection malfunction nozzles has a large amount and therefore a large storage capacity is required to store the data.

### SUMMARY

An image forming apparatus according to an aspect of the present disclosure includes a recording head, a control unit, an ejection malfunction nozzle detecting unit, and a storage device. The recording head is configured to eject ink corresponding to an image to be printed, using arranged nozzles. The control unit is configured to determine nozzles corresponding to the image to be printed, correspondingly to a position of a print sheet, and cause the recording head to eject ink from the nozzles. The ejection malfunction nozzle detecting unit is configured to (a) print plural test patterns on a print sheet using the recording head, and (b) detect ejection malfunction nozzles on the basis of scanned images of the plural test patterns. The storage device is configured to store ejection malfunction nozzle data that indicates the detected ejection malfunction nozzles. Further, the plural test patterns are line-shaped or band-shaped images for which a correction process has been performed at plural nozzle positions with a predetermined period. The nozzle positions of the plural test patterns are specified with offset positions different from each other. Furthermore, the ejection malfunction nozzle detecting unit (a) determines a test pattern that densities at periodical ejection malfunction positions have been corrected among the plural test patterns on the basis of density distributions of scanned image of the test patterns, and (b) stores as the ejection malfunction nozzle data an offset position of the determined test pattern into the storage device.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a block diagram that indicates an electronic configuration of the image forming apparatus 10 in the embodiment according to the present disclosure;

FIG. 4 shows a diagram that indicates an example of a test chart on which plural test pattern have been printed;

FIG. 5 shows a diagram that explains a test pattern 111 with no ejection malfunction nozzles and a density distribution (brightness distribution) of a scanned image of the test pattern 111;

FIG. 6 shows a diagram that explains a test pattern 111 with periodical ejection malfunction nozzles and a density distribution (brightness distribution) of a scanned image of the test pattern 111;

FIG. 7 shows a diagram that explains a test pattern 112-3 with periodical ejection malfunction nozzles as shown in FIG. 6 and a density distribution (brightness distribution) of a scanned image of the test pattern 112-3;

FIG. 8 shows a diagram that explains a test pattern 112-4 with periodical ejection malfunction nozzles as shown in FIG. 6 and a density distribution (brightness distribution) of a scanned image of the test pattern 112-4;

FIG. 9 shows a diagram that explains a test pattern 112-5 with periodical ejection malfunction nozzles as shown in FIG. 6 and a density distribution (brightness distribution) of a scanned image of the test pattern 112-5; and

FIG. 10 shows a diagram that explains a test pattern 112-6 with periodical ejection malfunction nozzles as shown in FIG. 6 and a density distribution (brightness distribution) of a scanned image of the test pattern 112-6.

### DETAILED DESCRIPTION

Hereinafter, embodiments according to an aspect of the present disclosure will be explained with reference to drawings.

### Embodiment 1

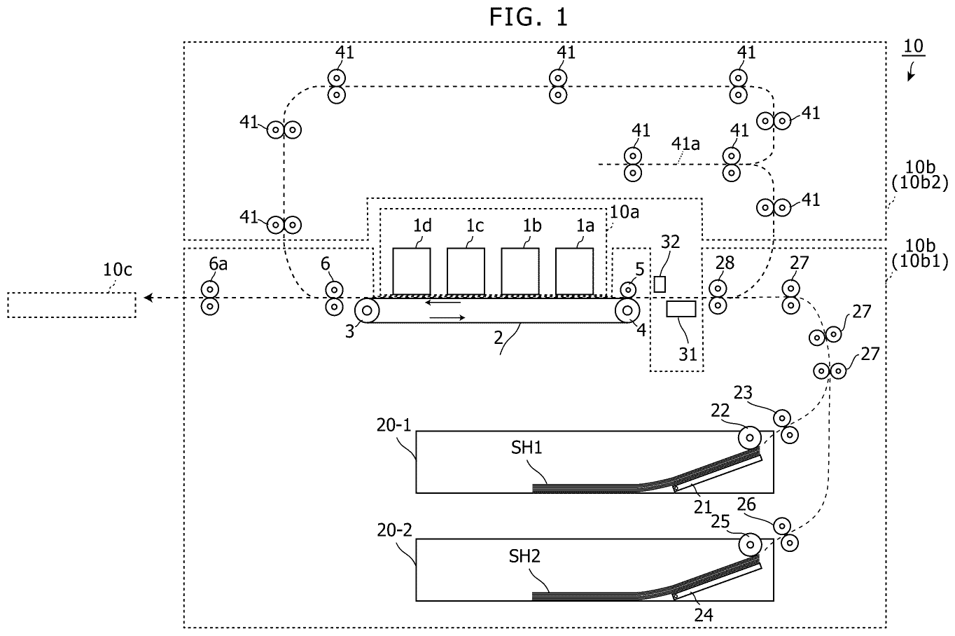

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type head units 1a to 1d corresponding to four ink colors: Cyan, Magenta, Yellow, and Black.

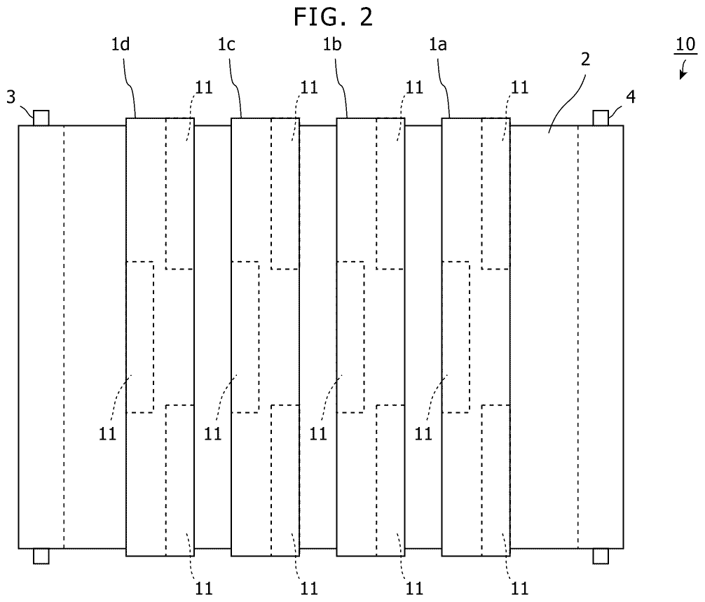

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11. The head unit 11 of the recording head 1a, 1b, 1c or 1d includes plural nozzles arranged 2-dimensionally; plural pressure chambers that are connected to the plural nozzles respectively and to which ink is supplied; and plural piezoelectricity actuators that are installed in the pressure chambers, are driven by a driving signal corresponding to image data of an image to be printed and pushes ink from the pressure chambers to the nozzles and thereby cause the nozzles to eject ink; and ejects ink corresponding to the image to be printed from the nozzles.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

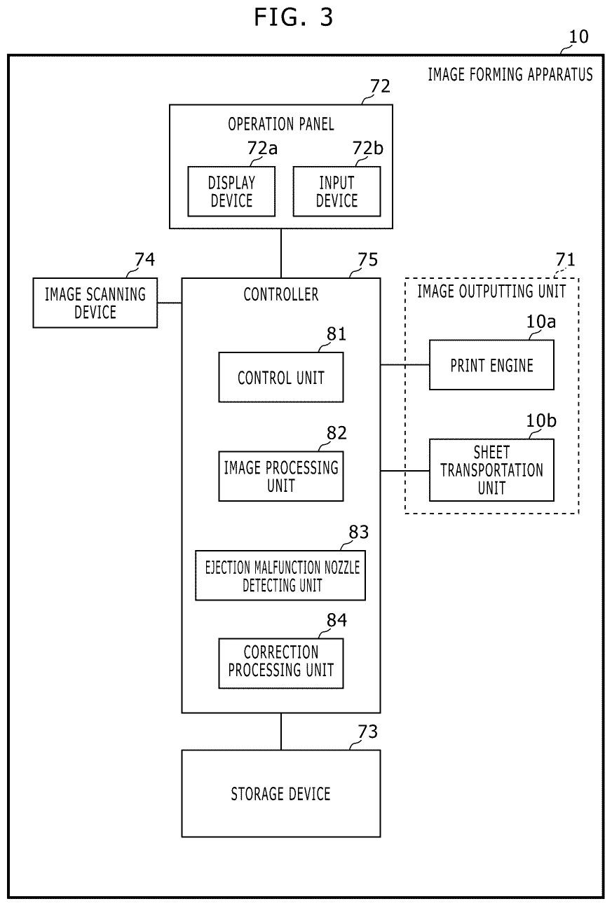

FIG. 3 shows a block diagram that indicates an electronic configuration of the image forming apparatus 10 in the embodiment according to the present disclosure. As shown in FIG. 3, the image forming apparatus 10 includes not only an image outputting unit 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10. In the storage device 73, ejection malfunction nozzle data mentioned below is stored.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, an ejection malfunction nozzle detecting unit 83, and a correction processing unit 84.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. Specifically, the control unit 81 supplies a driving signal to each of the piezoelectricity actuators in the head unit 11 and thereby causes to eject ink from the nozzles. The image processing unit 82 performs a predetermined image process such as RIP (Raster Image Processing), color conversion, halftoning and/or the like for image data of a printing image.

As mentioned, the control unit 81 causes the print engine 10a to print a user document image based on printing image data specified by a user.

In this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process. Specifically, in the automatic centering function, the control unit 81 changes a depicting position of the image to be printed, in a primary scanning direction by a difference between a reference center position of the print engine 10a and the actual sheet center position. In this embodiment, because the nozzles of the recording heads 1a to 1d do not move, a nozzle corresponding to each pixel in the image to be printed is changed correspondingly to the depicting position of the image to be printed.

As mentioned, the control unit 81 determines nozzles corresponding to the image to be printed (a nozzle corresponding to each pixel), correspondingly to a position of a print sheet, and causes the recording heads 1a to 1d to eject ink from the determined nozzles.

Using the control unit 81, the ejection malfunction nozzle detecting unit 83 (a) prints plural test patterns on a print sheet using the recording heads 1a to 1d, and (b) detects an ejection malfunction nozzle (i.e. a nozzle of which non ejection, ejection deviation (deviation of an ink droplet hitting position or the like occurs) on the basis of scanned images of the test patterns. The test patterns are individually printed for each of the ink colors.

In this embodiment, the line sensor 31 is installed to detect a position of a print sheet, and therefore, for example, after the aforementioned test pattern is printed on the print sheet, the circulation transportation unit 10b2 transports the print sheet and the line sensor 31 scans an image of the printed test pattern.

If the line sensor 31 is used for the detection of the ink ejection malfunction positions as mentioned, the ink ejection malfunction positions are automatically detected, and then the print sheet on which the test pattern has been printed is outputted. Instead of the line sensor 31, the print sheet on which the test pattern has been printed may be immediately outputted and set on the image scanning device 74 by a user, and the image on the print sheet may be scanned by the image scanning device 74.

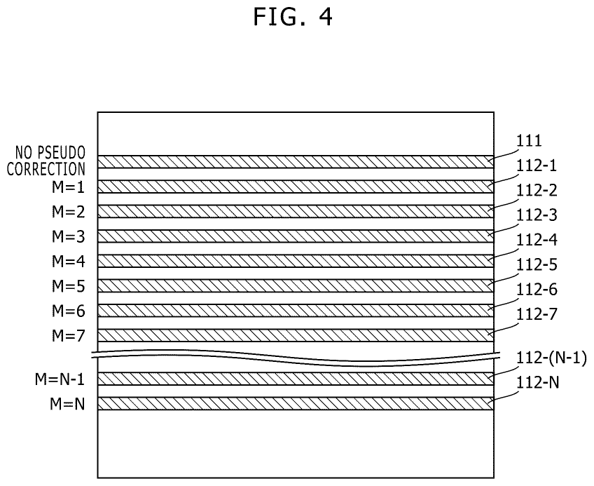

FIG. 4 shows a diagram that indicates an example of a test chart on which plural test pattern have been printed. As shown in FIG. 4, the aforementioned plural test patterns 112-1 to 112-N are line-shaped or band-shaped images for which at plural nozzle positions with a predetermined period N a correction process (pseudo correction assuming that nozzles at the plural nozzle positions are ejection malfunction nozzles) has been performed. The nozzle positions are specified by offset positions M different from each other.

In Embodiment 1, the predetermined period N is determined in advance.

It should be noted that as shown in FIG. 4 a test patter 111 for that a correction process is not performed is also printed with the test patterns 112-2 to 112-N.

Further, the ejection malfunction nozzle detecting unit 83 (a) determines a test pattern that densities at periodical ejection malfunction positions have been corrected among the plural test patterns 112-1 to 112-N on the basis of density distributions of scanned image of the test patterns 112-1 to 112-N, and (b) stores as the ejection malfunction nozzle data an offset position Mp of the determined test pattern into the storage device 73.

It should be noted that individually for each of the recording head 1a to 1d (i.e. for each ink color), ejection malfunction nozzles are determined as targets of the correction process as mentioned.

The correction processing unit 84 reads the offset position Mp from the storage device 73, determines plural ejection malfunction nozzles on the basis of the offset position Mp, and in an image to be printed, performs a correction process corresponding to the determined plural ejection malfunction nozzles.

The correction process sets the ejection malfunction nozzles to be non ejection, and increases ink ejection amounts to a predetermined amounts of nozzles of ejection positions adjacent to ejection positions of the ejection malfunction nozzles.

The aforementioned plural test patterns 112-1 to 112-N are test patterns of which the number is the same as the period N (the number of nozzles), and for a test pattern 112-M, nozzle positions at which an ink amount of an ink droplet is increased in the correction process are N×n+M−1 and N×n+M+1 for plural integers n=0, . . . , (P/N) (where P is the number of all nozzles (i.e. the number of dot positions) in a primary scanning direction). Further, nozzle positions at which an ink amount of an ink droplet is set to be zero in the correction process are N×n+M for plural integers n=0, . . . , (P/N).

Specifically, in the correction process, pixels corresponding to the ejection malfunction nozzles are determined in an image to be printed, and pixel values of the pixels are changed to values corresponding to non ejection or the increased ink ejection amounts.

The following part explains a behavior of the image forming apparatus 10.

### (a) Detection of Ejection Malfunction Nozzles

Using the control unit 81, the ejection malfunction nozzle detecting unit 83 causes the image outputting unit 71 to print the aforementioned test patterns 111, 112-1 to 112-N on a print sheet.

Subsequently, the ejection malfunction nozzle detecting unit 83 acquires scanned images of the plural test patterns using the line sensor 31 or the image scanning device 74.

Subsequently, the ejection malfunction nozzle detecting unit 83 determines primary-scanning-directional density distributions of scanned images of the test patterns 111, 112-1 to 112-N, and on the basis of the determined density distributions, determines a test pattern that densities at periodical ejection malfunction positions has been corrected; and stores as the ejection malfunction nozzle data an offset position Mp of the determined test pattern into the storage device 73.

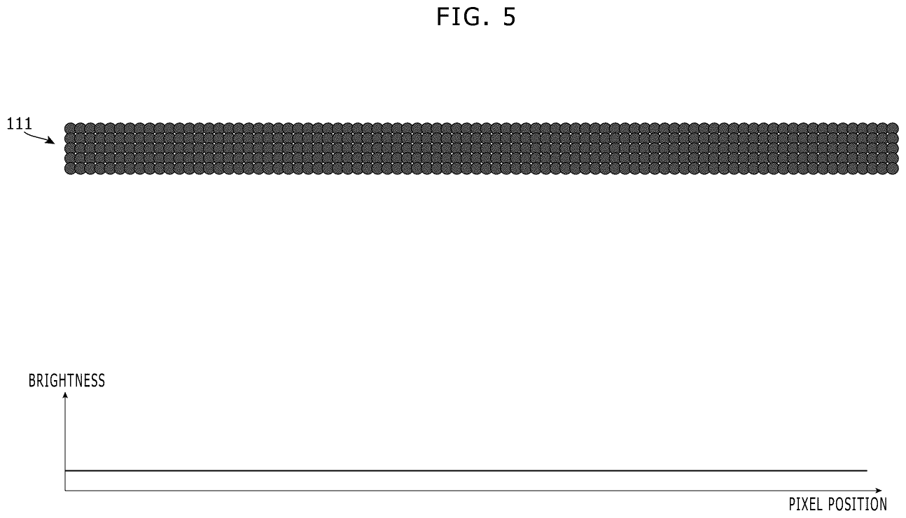

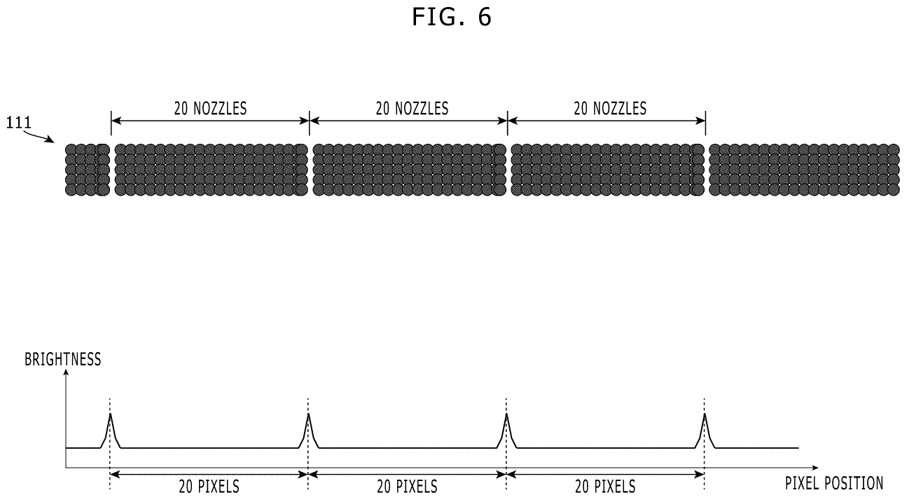

FIG. 5 shows a diagram that explains a test pattern 111 with no ejection malfunction nozzles and a density distribution (brightness distribution) of a scanned image of the test pattern 111. FIG. 6 shows a diagram that explains a test pattern 111 with periodical ejection malfunction nozzles (of 20-nozzle (20-dot) period) and a density distribution (brightness distribution) of a scanned image of the test pattern 111. A period of the ejection malfunction nozzles shown in FIG. 6 is an example.

For example, as shown in FIG. 5, if there are no ejection malfunction nozzles, then a primary-scanning-directional density distribution of the scanned image is substantially constant; but as shown in FIG. 6 for example, if there are periodical ejection malfunction nozzles, then periodical dips (peaks in the brightness distribution) appear in the primary-scanning-directional density distribution of the scanned image. Here, if a dot resolution of the test patterns (i.e. nozzle density) is identical to a resolution of the scanned images, then the density dips (brightness peaks) appear with a 20-pixel period.

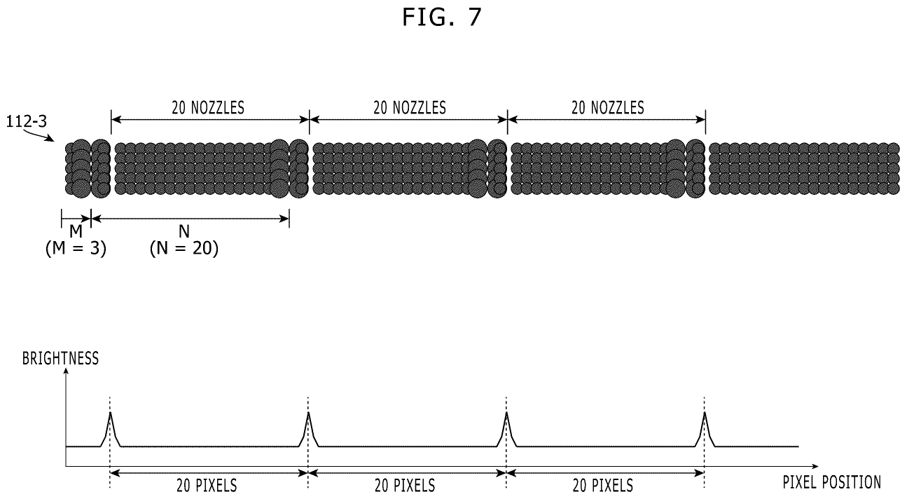

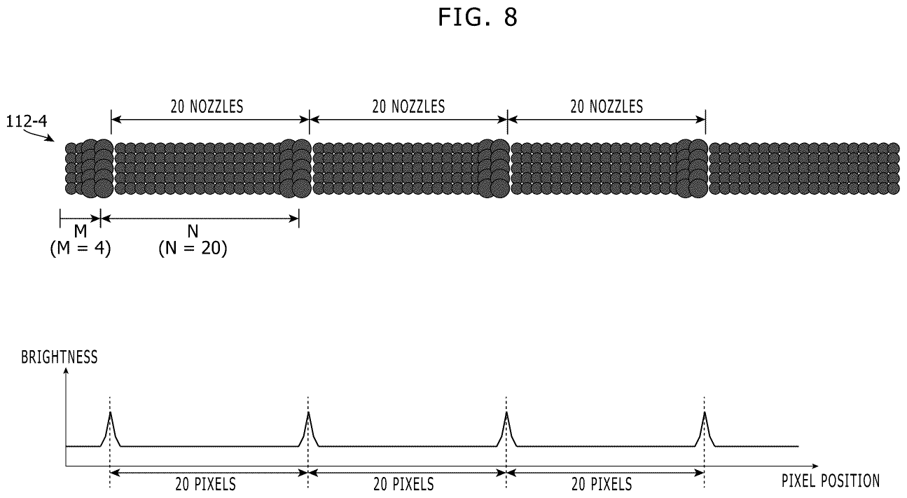

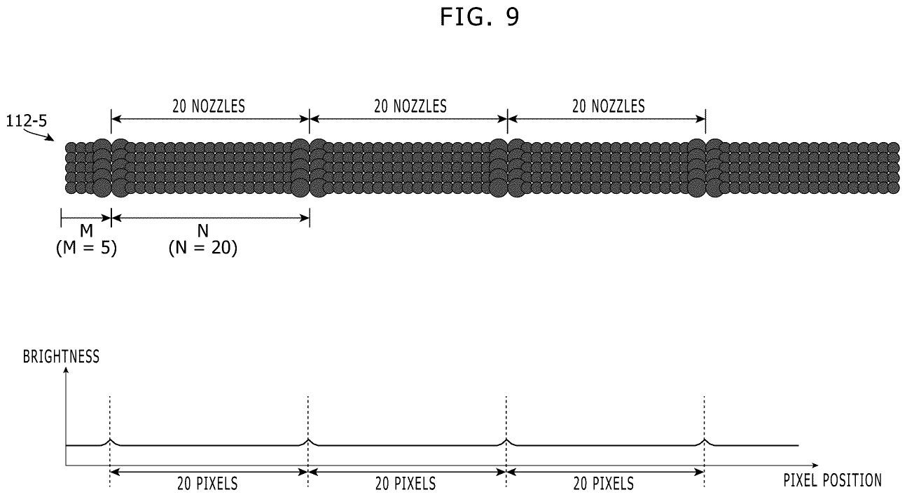

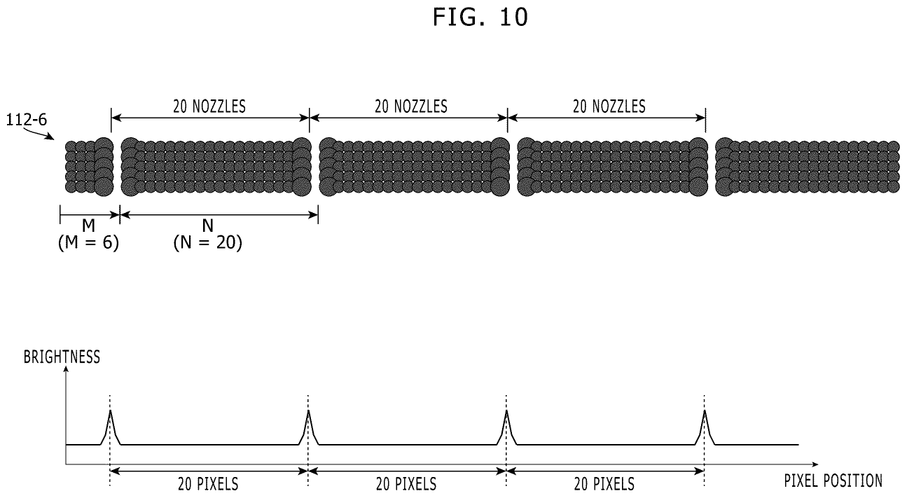

FIG. 7 shows a diagram that explains a test pattern 112-3 with periodical ejection malfunction nozzles as shown in FIG. 6 and a density distribution (brightness distribution) of a scanned image of the test pattern 112-3. FIG. 8 shows a diagram that explains a test pattern 112-4 with periodical ejection malfunction nozzles as shown in FIG. 6 and a density distribution (brightness distribution) of a scanned image of the test pattern 112-4. FIG. 9 shows a diagram that explains a test pattern 112-5 with periodical ejection malfunction nozzles as shown in FIG. 6 and a density distribution (brightness distribution) of a scanned image of the test pattern 112-5. FIG. 10 shows a diagram that explains a test pattern 112-6 with periodical ejection malfunction nozzles as shown in FIG. 6 and a density distribution (brightness distribution) of a scanned image of the test pattern 112-6.

For example, as shown in FIGS. 7 to 10 for example, the nozzle positions of the correction process for each test pattern 112-i are shifted one-nozzle by one-nozzle from the test pattern 112-1 to the test pattern 112-N, and as shown in FIG. 9 for example, if two dots of which droplet ink amounts are increased in the correction process are located at both sides of a dot position of an ejection malfunction nozzle, then a dip in the density distribution of the scanned image (a peak in the brightness distribution) becomes small (compared with a dip of another test pattern 111 or 112-j) and an offset position in this case (here, M=5) is determined as the offset position Mp that the correction process is preferably performed.

As mentioned, the offset position Mp of ejection malfunction nozzles as a target of the correction process are determined.

### (b) Behavior for Printing

When receiving a print request, the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this behavior, prior to start of printing, the correction processing unit 84 reads the aforementioned ejection malfunction nozzle data (the offset position Mp) from the storage device 73 and determines ejection malfunction nozzles; and upon detecting a position of the print sheet by the line sensor 31, (a) determines nozzles corresponding to pixels in the aforementioned image, and (b) determines pixels corresponding to the ejection malfunction nozzles in the aforementioned image and performs the correction process for the pixels and adjacent pixels of them. Subsequently, the control unit 81 performs the aforementioned printing on the basis of the image data after the correction process.

As mentioned, in Embodiment 1, the plural test patterns 112-1 to 112-N are line-shaped or band-shaped images for which a correction process has been performed at plural nozzle positions with a predetermined period N, and the nozzle positions of the plural test patterns are specified with offset positions M different from each other. Further, the ejection malfunction nozzle detecting unit 83 (a) determines a test pattern that densities at periodical ejection malfunction positions have been corrected among the plural test patterns 112-1 to 112-N on the basis of density distributions of scanned image of the test patterns 112-1 to 112-N, and (b) stores as the ejection malfunction nozzle data an offset position Mp of the determined test pattern into the storage device 73.

Consequently, a small storage capacity is sufficient to store the ejection malfunction data because nozzles positions of plural periodical ejection malfunction nozzles are not individually stored and only the offset position Mp is stored for the plural periodical ejection malfunction nozzles.

Further, a resolution of the scanned images can be smaller than a dot resolution of the test patterns (nozzle density), and even in such a case, the offset position Mp is favorably determined on the basis of a strength of the periodical density dips (periodical brightness peaks).

### Embodiment 2

In Embodiment 2, if the aforementioned period N has not been uniquely determined, then the period N is searched for and determined together with the aforementioned offset position Mp using test patterns.

In Embodiment 2, for each period N(i) of plural periods N(1) to N(K), the plural test patterns are line-shaped or band-shaped image for which a correction process has been performed at plural nozzle positions with this period N(i).

Further, in Embodiment 2, the ejection malfunction nozzle detecting unit 83 (a) determines a test pattern that densities at periodical ejection malfunction positions has been corrected among the plural test patterns on the basis of density distributions of scanned image of the test patterns, and (b) stores as the ejection malfunction nozzle data the period N(p) and the offset position Mp of the determined test pattern into the storage device 73.

The correction processing unit 84 reads the period N(p) and the offset position Mp from the storage device 73, determines plural ejection malfunction nozzles on the basis of the period N(p) and the offset position Mp, and in an image to be printed, performs a correction process corresponding to the determined plural ejection malfunction nozzles.

Other parts of the configuration and behaviors of the image forming apparatus in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiments, the aforementioned test patterns may be printed on a single print sheet and images of the test patterns may be acquired as the aforementioned scanned images from the single print sheet; and alternatively, the aforementioned test patterns may be printed dispersedly on plural print sheets and images of the test patterns may be acquired as the aforementioned scanned images from the plural print sheets.

Further, in the aforementioned embodiments, if there is a non-periodical ejection malfunction nozzle, a nozzle position of the non-periodical ejection malfunction nozzle may be included in the ejection malfunction nozzle data, and the correction processing unit 84 may perform a correction process for the non-periodical ejection malfunction nozzle on the basis of data of the nozzle position, individually from the correction process for the periodical ejection malfunction nozzles.

Furthermore, in the aforementioned embodiments, if it is determined whether there is an ejection malfunction nozzle or not on the basis of a density distribution of a scanned image of the test pattern 111 and consequently it is determined that there is an ejection malfunction nozzle, then the determination of the aforementioned offset position Mp (and the like) from the scanned images may be performed; and otherwise, if not, then the determination of the aforementioned offset position Mp (and the like) from the scanned images may not be performed.

What is claimed is:

1. An image forming apparatus, comprising:
a recording head configured to eject ink corresponding to an image to be printed, using arranged nozzles;
a control unit configured determine nozzles corresponding to the image to be printed, correspondingly to a position of a print sheet, and cause the recording head to eject ink from the nozzles;
an ejection malfunction nozzle detecting unit configured to (a) print plural test patterns on a print sheet using the recording head, and (b) detect ejection malfunction nozzles on the basis of scanned images of the plural test patterns; and
a storage device configured to store ejection malfunction nozzle data that indicates the detected ejection malfunction nozzles;
wherein the plural test patterns are line-shaped or band-shaped images for which a correction process has been performed at plural nozzle positions with a predetermined period;
the nozzle positions of the plural test patterns are specified with offset positions different from each other; and
the ejection malfunction nozzle detecting unit (a) determines a test pattern that densities at periodical ejection malfunction positions have been corrected among the plural test patterns on the basis of density distributions of scanned image of the test patterns, and (b) stores as the ejection malfunction nozzle data an offset position of the determined test pattern into the storage device.

2. The image forming apparatus according to claim 1, wherein for each period of plural periods, the plural test patterns are line-shaped or band-shaped image for which a correction process has been performed at plural nozzle positions with this period;
the ejection malfunction nozzle detecting unit (a) determines a test pattern that densities at periodical ejection malfunction positions has been corrected among the plural test patterns on the basis of density distributions of scanned image of the test patterns, and (b) stores as the ejection malfunction nozzle data the period and the offset position of the determined test pattern into the storage device.

3. The image forming apparatus according to claim 1, further comprising a correction processing unit configured to read the offset position from the storage device, determine plural ejection malfunction nozzles on the basis of the offset position, and perform a correction process corresponding to the determined plural ejection malfunction nozzles in the image to be printed.

4. The image forming apparatus according to claim 1, wherein the correction processing unit sets the ejection malfunction nozzles to be non ejection, and increases ink ejection amounts of nozzles of ejection positions adjacent to ejection positions of the ejection malfunction nozzles.
